(19) United States
(12) Patent Application Publication
(10) Pub. No.: US 2008/0241782 A1
(43) Pub. Date: Oct. 2, 2008

(54) TWO-PART SELF-LIGATING ORTHODONTIC BRACKET HAVING LATERAL GUIDING MECHANISM

(76) Inventors: Norbert Abels, Homburg (DE); Claus H. Backes, Saarbrucken (DE)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/694,607

(22) Filed: Mar. 30, 2007

(51) Int. Cl. A61C 7/28

(52) U.S. Cl. 433/10

(57) ABSTRACT

Two-piece self-ligating orthodontic brackets including a bracket base, at least one arch wire slot formed in the bracket base adapted to receive an arch wire therein, and a ligation cover that is hingedly attachable to the bracket base. The bracket further includes means for resisting lateral movement of an occlusal front portion of the ligation cover so as to guide the occlusal front portion of the cover as the cover is closed over the bracket base. For example, the bracket base may include a pair of spaced apart guides which extend from the base in a labial-buccal direction so as to define a receiving cavity between the guides. The cover includes a corresponding occlusal front nose portion which is configured to be received within the receiving cavity when the cover is closed.

### BACKGROUND OF THE INVENTION

1. The Field of the Invention

The present invention relates to orthodontic brackets, more particularly to two-part self-ligating orthodontic brackets that include a bracket base, at least one slot for receiving an arch wire, and a ligating cover.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth to correct overjets or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets, more particularly the orthodontic bases, are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the slot of each bracket. The arch wire acts as a template or track to guide movement of the teeth into proper alignment.

There are two distinct classes of orthodontic brackets: those that require the use of ligatures to fasten the arch wire to the bracket, and those that are self-ligating. In brackets of the first class, small ligature wires are typically used to hold the arch wire in a securely seated position in the brackets. Ligatures or some other form of fastening means are essential to ensure that the tensioned arch wire is properly positioned around the dental arch, and to prevent the wire from being dislodged from the bracket slots during chewing of food, brushing of teeth, or application of other forces. One type of commercially available ligature is a small, elastomeric O-ring, which is installed by stretching the O-ring around small wings known as “tie wings” that are connected to the bracket body. Metal ligatures are also used to retain arch wires within the bracket slots.

In an effort to simplify the process of installing braces, a variety of self-ligating brackets have been developed. The term “self-ligating bracket” refers to a class of orthodontic brackets that include some sort of cover, whether separate from or hingedly or slidably attached to the base, which encloses or otherwise retains the arch wire within the slot of the base.

A two-part orthodontic bracket having a base, an arch wire slot and a ligation cover is disclosed in the inventors earlier U.S. Pat. No. 6,964,565, herein incorporated by reference in its entirety. Such brackets advantageously provide the ease of use benefits associated with self-ligating brackets, while also allowing at least the bracket base to be formed of a material (e.g., metal or ceramic) that provides a relatively high strength so as to resist deformation forces, which can be particularly important in the area surrounding the arch wire slot.

In general, while conventional self-ligating brackets may provide effective orthodontic treatment, they can be vulnerable to lateral movements or forces that might laterally dislodge the ligation cover when moved towards the closed position. In addition, conventional self-ligating brackets are often prone to being accidentally or deliberately opened by the patient (e.g., by the patient's fingernail prying open the cover).

### BRIEF SUMMARY OF THE PREFERRED EMBODIMENTS

The present invention is directed to two-piece self-ligating orthodontic brackets which include a bracket base, at least one arch wire slot formed in the bracket base adapted to receive an arch wire therein, a ligation cover that is hingedly attachable to the bracket base and that can be selectively moved relative to the bracket base between an open non-ligating position relative to the arch wire slot and a closed, ligating position relative to the arch wire slot, and a hinge element for hingedly connecting the ligation cover to the bracket base. The bracket further includes means for guiding an occlusal front portion of the ligation cover as the cover is closed over the bracket base to prevent lateral movement. For example, the bracket base may include a pair of laterally spaced apart guides which extend from the base in a labial-buccal direction so as to define a receiving cavity between the guides. The cover includes a corresponding occlusal front nose portion which is configured to be received within the receiving cavity when the cover is closed.

The bracket advantageously provides guidance to the front occlusal portion of the ligation cover so as to resist lateral movement as it approaches the closed position, as the front nose portion of the cover is received between the spaced apart guides formed on the bracket base. In addition, the sandwiched mating configuration of the front nose portion between the guides provides increased strength to the occlusal front portion of the cover when subjected to lateral forces (e.g., applied by the tongue, while chewing, or otherwise) so as to prevent lateral sliding, opening, or unintentional separation of the cover from the bracket base.

In one embodiment, the bracket advantageously further includes a safety unlocking feature so as to prevent or at least inhibit opening of the ligation cover by a patient when the ligation cover is closed. In one embodiment, a safety unlocking recess is formed into the occlusal front nose portion of the cover and/or within the bracket base to limit the ability of a patient to unlock the cover from the base. Such a configuration requires use of a scaler or other dental tool which is inserted within the recess and used to apply an opening force to unlock the cover from the bracket base. The unlocking recess and front nose portion of the cover are advantageously relatively narrow so as to prevent a patient from being able to open the cover of the bracket with their own fingernail. For example, the unlocking recess may have a width between about 0.25 mm and about 1 mm, more preferably between about 0.5 mm and about 0.75 mm.

The front nose portion of the cover is also narrow so that it does not extend along the full width of the occlusal front surface of the bracket, as the guides are located to either side of the front nose portion of the cover along the front profile of the bracket. The presence of the guides effectively prevents or at least inhibits a patient from pulling the cover open with a fingernail, as they block access to a substantial portion of the occlusal front nose portion that would otherwise be accessible if the guides were absent. In other words, the guides limit the ability of a patient to insert a fingernail under the occlusal front nose portion and apply an opening force to the degree that would be required to unlock the cover.

The bracket base may advantageously be formed of metal, ceramic, or glass so as to provide high strength which is helpful in the region of the arch wire slot as it aids in transferring forces from the arch wire to the bracket base so as to effect movement of the teeth without deformation of the material surrounding the slot. Metal, ceramic, and/or glass materials are particularly strong so as to resist deformation, and for this reason these materials are preferred for manufacturing the bracket base.

The ligation cover may advantageously be formed of metal, ceramic, glass, or a polymeric resin. In addition to different choice of material properties that such a two-part bracket provides (i.e., the cover may be of a different material than the bracket base), such a two-part bracket allows the patient and practitioner some flexibility in creating a desired aesthetic appearance to the bracket and the overall bracket system, as the ligation cover(s) may be of a different material (and/or color and/or texture) than the bracket base(s). For example, a bracket base may be of a first color, while the associated ligation cover is of a second different color. Many patients (typically those who are young) enjoy the aesthetic appearance provided by brackets exhibiting bright and easily noticeable colors. In addition, the ligation cover and/or bracket base may include a decorative image, graphic, figure, pattern, design, or other decoration according to the aesthetic wishes of the patient.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary orthodontic bracket according to the present invention shown in the closed position;

FIG. 2 is a perspective view of the orthodontic bracket of FIG. 1 with the ligation cover in an open configuration relative to the bracket base and arch wire slot such that the arch wire slot is unoccluded by the hingedly attached ligation cover;

FIG. 3A is a cross sectional view of the orthodontic bracket shown in FIG. 1 as the cover is being closed;

FIG. 3B is a cross sectional view of the orthodontic bracket shown in FIG. 3A as the cover progressively continues towards a closed position;

FIG. 3C is a cross sectional view of the orthodontic bracket shown in FIG. 3A with the cover closed as in FIG. 1;

FIG. 4A is a perspective view of an unattached bracket base from the bracket of FIGS. 1 and 2;

FIG. 4B is a perspective view of an unattached ligation cover from the bracket of FIGS. 1 and 2;

FIG. 5A is a perspective view of the bracket base and ligation cover of FIGS. 4A and 4B, respectively, with the ligation cover aligned in a position for attachment to the bracket base;

FIG. 5B is an elevation cross-sectional view of the rear of the orthodontic bracket of FIG. 1;

FIG. 6A is a perspective view of an alternative orthodontic bracket according to the present invention including an alternative means for providing hinged attachment, with the cover shown in the closed position;

FIG. 6B is a perspective view of the alternative orthodontic bracket of FIG. 6A with the ligation cover in an open configuration;

FIG. 6C is a cross sectional view of the orthodontic bracket shown in FIG. 6A with the cover completely closed and latched;

FIG. 7A is a perspective view of an unattached bracket base from the bracket of FIGS. 6A-6B;

FIG. 7B is an elevation cross-sectional view of the rear of the bracket base of FIG. 7A; and

FIG. 8 is a perspective view of the orthodontic bracket of FIG. 1 attached to the tooth of a patient, and where a scaler is being positioned to open the cover.

### DETAILED DESCRIPTION OF THE PREFERRED EMBODIMENTS

### I. Introduction

The invention generally relates to a two-part self-ligating orthodontic bracket which includes a bracket base, at least one arch wire slot formed in the bracket base, a ligation cover, means for hingedly connecting the ligation cover to the bracket base, and means for resisting lateral movement so as to guide the front occlusal portion of the cover as the cover is progressively closed over the bracket base to prevent lateral movement. An example of such means for resisting lateral movement may comprise a pair of spaced apart guides disposed on the bracket base near an occlusal edge of the bracket base (e.g., one guide may be disposed near an occlusal-mesial comer of the bracket base and the other guide may be disposed near an occlusal-distal comer of the bracket base). The guides extend from the base in a labial-buccal direction so as to define a receiving cavity between the guides. This receiving cavity is configured to receive a corresponding occlusal front nose portion of the ligation cover, which is guided during closure between the laterally disposed guides of the base.

The guides and occlusal front nose portion ensure that the occlusal front nose portion of the cover is properly aligned with the bracket base during closure so as to resist any lateral movement of the front portion of the cover. The configuration also advantageously provides an added degree of strength so as to resist laterally applied forces that may be encountered during use.

### II. Exemplary Orthodontic Brackets

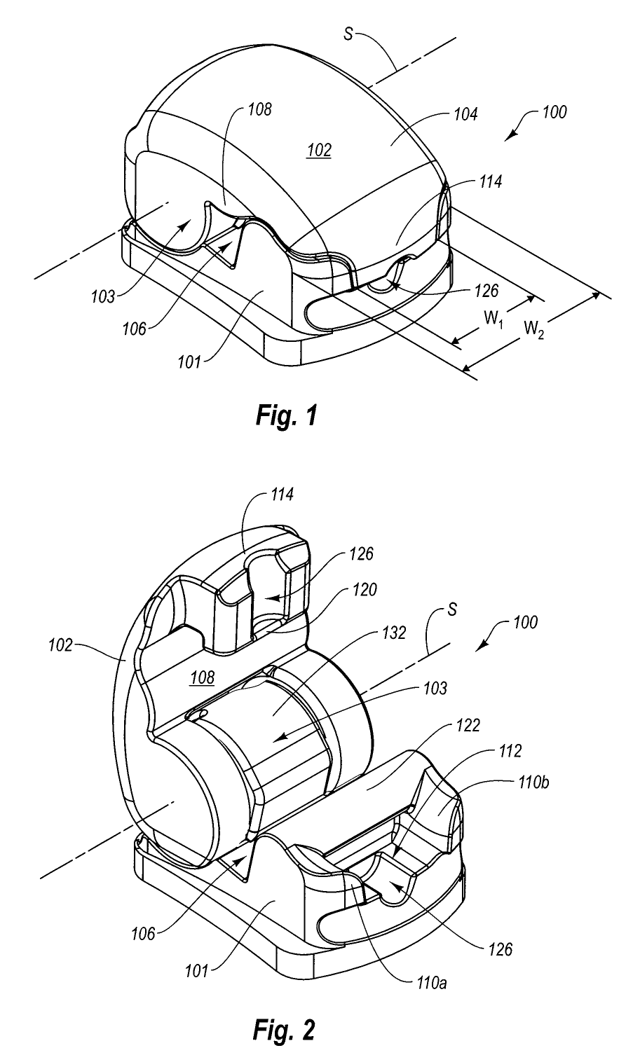

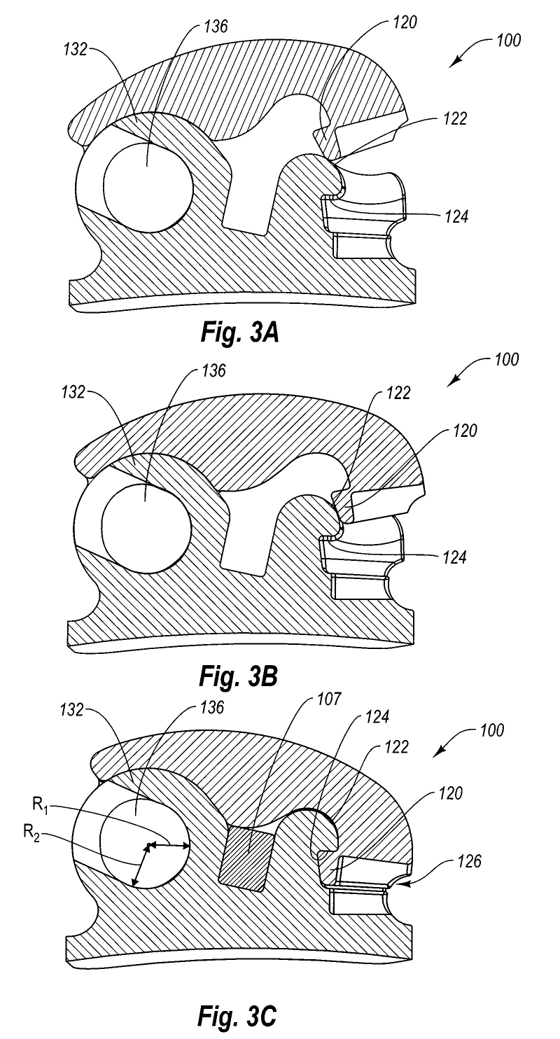

FIGS. 1-5B illustrate an exemplary orthodontic bracket 100. Bracket 100 includes a bracket base 101 and ligation cover 102. Once assembled, the base 101 and cover 102 are pivotally connected to each other via a joint 103 which has a horizontal pivot axis S about which first interchangeable ligation cover 102 can be pivoted from its completely closed and latched position shown in FIG. 1 to an open position shown in FIG. 2.

In the embodiment shown, ligation cover 102 advantageously comprises a cover having a smooth, curved outer surface 104 which extends from near the rear gingival edge of the cover to the front occlusal edge. The cover 102 advantageously covers substantially all of the top labial-buccal surface of bracket base 101. This prevents or reduces potential injury and discomfort to the patient, as well as the tendency for food or other foreign substances to catch or adhere within crevices of the orthodontic bracket 100.

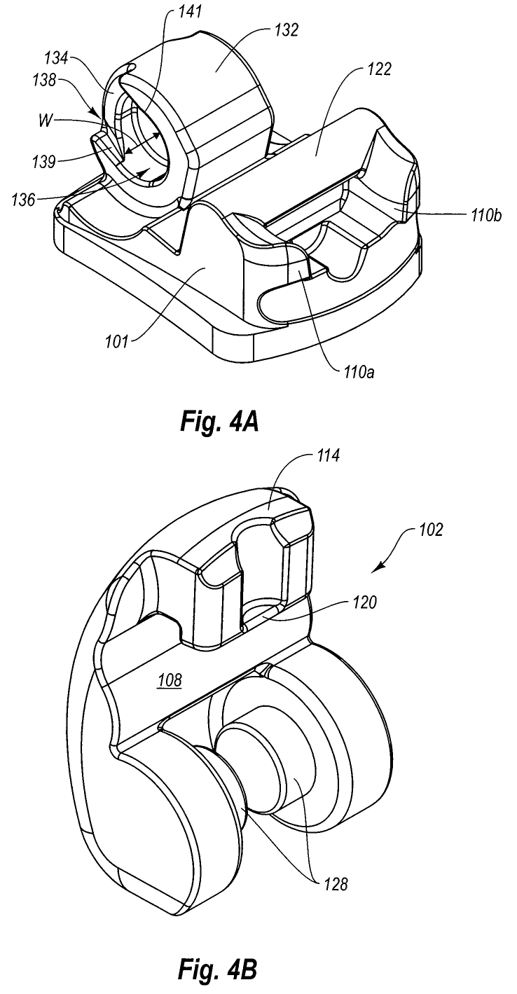

As further illustrated in FIG. 1, ligation cover 102, while in a completely closed or latched state relative to the bracket base 101, covers or occludes arch wire slot 106 designed to receive therein an arch wire (107). Ligation cover 102 may advantageously be provided with a bearing extension 108 designed to bear against and hold an arch wire in slot 106 (i.e., so as to provide active ligation) when ligation cover 102 is closed or latched relative to the bracket base 101. As illustrated, bearing extension 108 may advantageously be convexly curved outward so as to contact and bear against only a small portion of an arch wire 107 (see FIG. 3C). Such a configuration provides sufficient bearing force so as to provide for active ligation while minimizing the force required to effect movement of the tooth, so as to balance these two criteria (i.e., so as to provide for relatively fast movement of the teeth while also avoiding unnecessary discomfort to the patient).

As illustrated, bracket base 101 includes a pair of guides 110a and 110b. Guides 110a and 110b are disposed at or near the occlusal edge of base 101 and extend upwardly from base 101 in a labial-buccal direction. In the illustrated example, guide 110a is disposed at or near one of the occlusal corners (e.g., the occlusal-distal corner), while the other guide 110b is oppositely disposed at or near the opposite occlusal comer (e.g., the occlusal-mesial corner). Although the relative terms mesial and distal depend on the placement of the bracket upon the upper or lower teeth, this is not necessarily important as the bracket may be symmetrical, and in any case it is sufficient to note that the guides are oppositely disposed along the occlusal edge of bracket base 101. A receiving cavity 112 is defined between guides 110a and 110b, which cavity is configured to receive an occlusal front nose portion 114 of cover 102.

As cover 102 is progressively closed over bracket base 101, occlusal front nose portion 114 enters cavity 112, bounded by guides 110a and 110b. As closing progresses, guides 110a and 110b act to resist and limit any lateral sliding nose portion 114 of cover 102. In the completely closed configuration, front nose portion 114 is received between guides 110a and 110b, within cavity 112. The reception of front nose portion 114 provides an added degree of strength to resist any lateral forces, which might otherwise act to laterally displace the front portion of cover 102, which may otherwise result in a misalignment of the cover 102 with bracket base 101, and which may have undesirable effects upon the efficacy of the orthodontic bracket during orthodontic treatment. Guides 110a and 110b are an example of means for resisting lateral movement of the occlusal front portion of cover 102 during closure of cover 102. Other structures that provide resistance to lateral movement so as to guide front occlusal portion 114 during closure will be apparent to one skilled in the art, and such structures are within the scope of the meaning of the term “means for resisting lateral movement of an occlusal front portion of the ligation cover”.

As seen in FIG. 1, ligation cover 102 has a width W₁ at occlusal front nose portion 114 which is less than a width W₂ at an adjacent portion of ligation cover 102 which is gingival to occlusal front nose portion 114. The reduced width of front nose portion 114 advantageously allows it to be received within cavity 112 between guides 110a and 110b, while also providing cover 102 with a width sufficient to cover substantially all of the top labial-buccal surface of bracket base 101, which prevents or minimizes accumulation of food or other debris within crevices. In other words, cover 102 has a width along substantially its entire length which is substantially equal to the width of the bracket base 101 below. As such, cover 102 is advantageously able to cover substantially all crevices and rough edges of the labial-buccal surface of the bracket base so as to present a smooth outer surface, which is more comfortable for the patient and provides less opportunity for accumulation of food and debris.

Ligation cover 102 can be latched or locked to bracket base 101 by engagement of a latch mechanism in order to maintain ligation cover 102 in a closed or latched state. In the illustrated embodiment, a latch projection 120 (perhaps best seen in FIGS. 3A-3C) is provided within ligation cover 102 at a location spaced apart from joint 103. Latch projection 120 generally extends toward the bracket base 101 and is configured so as to snap over a latch bump 122 provided at the bracket base 101 in order to mechanically latch the interchangeable ligation cover 102 to the bracket base 101. FIGS. 3A-3C illustrate progressive cross-sections of bracket 100 as cover 102 is moved towards the closed position. As seen in FIG. 3A, latch projection 120 contacts latch bump 122 and is slightly elastically stretched as the cover 102 continues to be pressed closed, as shown in FIG. 3B. Under continued force, latch projection 120 eventually clears the end of latch bump 122, snapping back so as to reside within an angled keyway 124. Angled keyway 124 may be upwardly inclined at an angle so as to pull latch projection up into angled keyway, resulting in a tight lock of cover 102 to base 101.

For example, in such a configuration, even under increased pressure applied by arch wire against bearing extension 108, projection 120 is unlikely to be pulled out of angled keyway 124 and up over latch bump 122. In order to unlock cover 102 from base 101, a tool (e.g., a dental scaler) must be inserted within a safety unlocking recess 126, which may be formed within the cover 102 and or base 101 so as to provide access to the underside of front nose portion 114 and latch projection 120. A force is applied with the scaler or other tool to pull projection 120 out of angled keyway 124. Other latch mechanisms will be apparent to one skilled in the art.

Safety unlocking recess 126 is an example of means for preventing or inhibiting opening of the ligation cover 102 by a patient once cover 102 is closed and locked. Unlocking recess 126 and front nose portion 114 of the cover are advantageously relatively narrow so as to prevent or at least inhibit a patient from being able to unlock the cover of the bracket with their own fingernail. For example, the safety unlocking recess may have a width between about 0.25 mm and about 1 mm, more preferably between about 0.5 mm and about 0.75 mm.

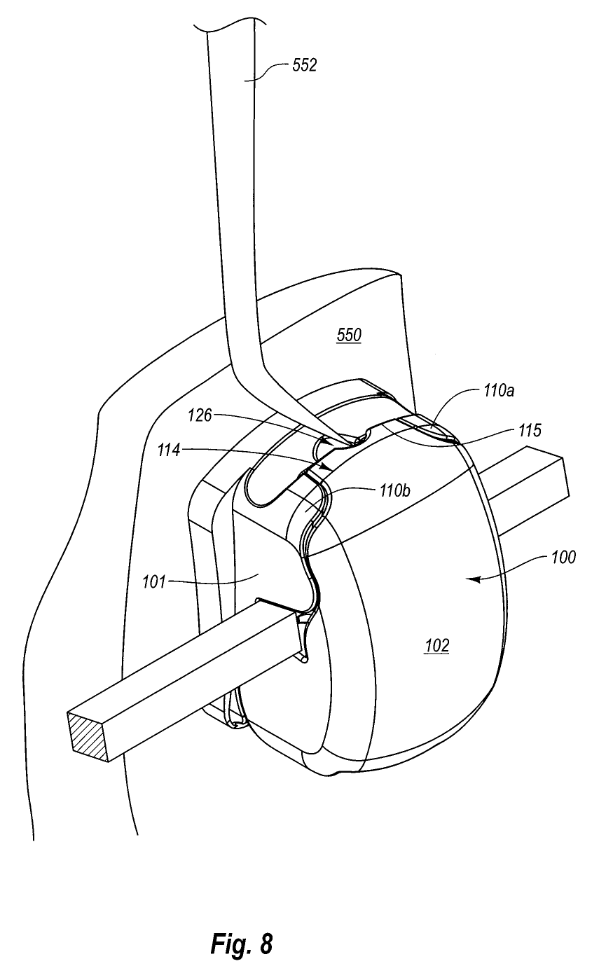

The front nose portion 114 of cover 102 is also narrow (W₁) so that it does not extend along the full width (W₂) of the occlusal front surface of the bracket, as the guides are located to either side of the front nose portion of the cover along the front profile of the bracket as viewed when closed (FIG. 1). The presence of guides 110a and 110b effectively block access to a substantial portion of the occlusal front nose portion that would otherwise be accessible if guides 110a and 110b were absent. In other words, guides 110a and 110b limit the ability of the patient to insert a fingernail under the occlusal front nose portion 114 in a way that would provide sufficient opening force to unlock the cover 102. As shown in FIG. 8, a dental scaler or other specialized tool is required to unlock cover 102 from base 101. Safety unlocking recess 126 and the narrowing of front nose portion 114 are examples of means for preventing or inhibiting opening of the ligation cover 102 by a patient once cover 102 is closed and locked. Other structures that provide a safety locking feature so as to prevent or at least inhibit opening of the cover by a patient (e.g., with a fingernail) once the cover is closed and locked will be apparent to one skilled in the art, and such structures are within the scope of the meaning of the term “means for preventing or inhibiting opening of the ligation cover by a patient when the ligation is closed”.

In the open position (FIG. 2), ligation cover 102 advantageously opens sufficiently so as to not occlude slot 106. For example, in one embodiment, cover 102 may rotate sufficiently so as to form an angle of at least about 60° when fully open, more preferably at least about 90° with bracket base 101 when fully open. Furthermore, the ligation cover may also be configured such that it is not biased to an occluding or closed position relative to the arch wire slot 106 when cover 102 is open. Such features are advantageous as they provide improved access when inserting or removing an arch wire from slot 106 as compared to a configuration where cover 102 is always biased to an occluding or closed position, or where the ligation cover 102 still substantially occludes or covers slot 106, even when fully open.

Joint 103 of bracket 100 is advantageously disposed apart from the edges of the bracket so as to allow cover 102 to cover most internal workings of the joint, which advantageously presents a relatively smooth outer surface with a minimum of crevices which may otherwise attract and trap food or debris. Joint 103 is an example of means for hingedly connecting ligation cover 102 to bracket base 101. Joint 103 has a horizontal pivot axis S about which ligation cover 102 can be pivoted from its completely closed and latched position shown in FIG. 1 to an open position shown in FIG. 2 in which arch wire slot 106 is unoccluded.

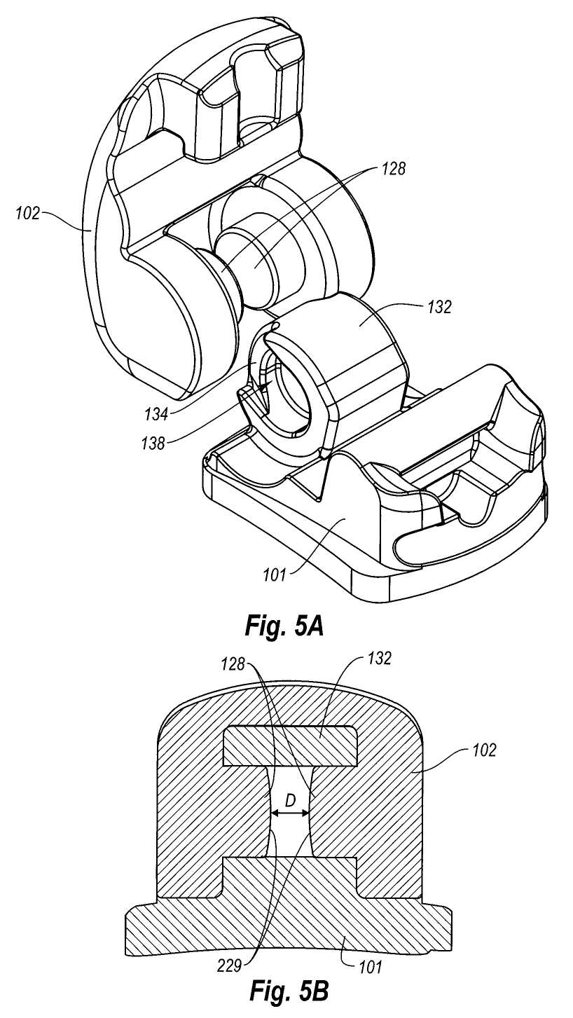

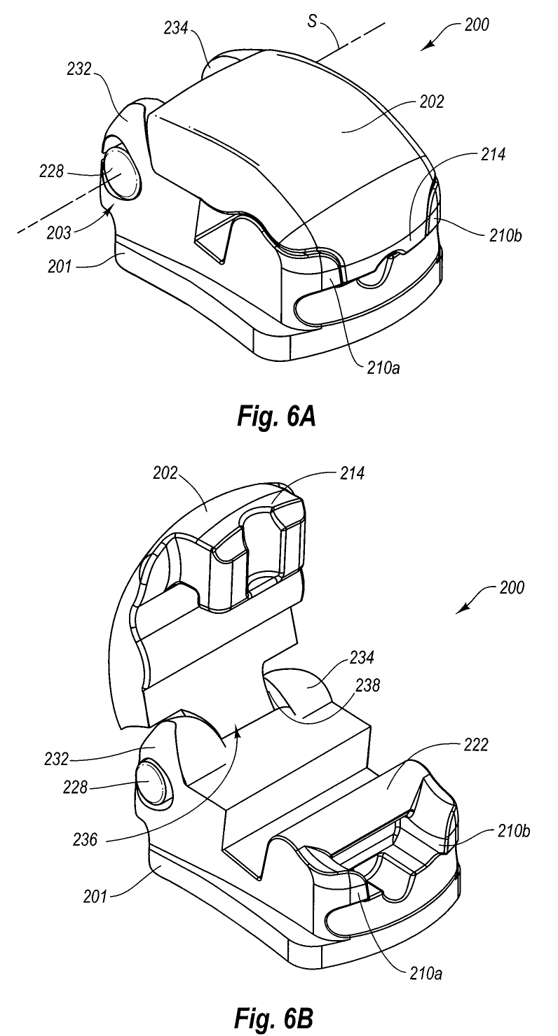

Ligation cover 102 includes a pair of inwardly oriented cylindrical pins 128, (perhaps best seen in FIGS. 4B and 5A). When cover 102 is hingedly attached to base 101, pins 128 are each received in opposite sides of a single centrally located link guide 132 that forms an integral portion of bracket base 101. The pins 128 and link guide 132 together comprise at least a portion of joint 103. The interaction between the pins 128 and link guide 132 allow the ligation cover 102 to be rotated about the pivot axis S between the open and closed positions. Joint 103 is an example of hinge means for hingedly connecting an interchangeable ligation cover to a bracket base.

Pins 128 are connected to cover 102 so as to be in a spaced-apart relationship and are oriented inwardly relative to one another. As seen in FIG. 4B, the outer surfaces on either side of link guide 132 also include sloped guide channels 138 defined by a lower sloped surface 139 and an upper sloped surface 141. In order to attach interchangeable ligation cover 102 to base 101, the cylindrical pins 128 of the interchangeable ligation cover 102 are inserted into the guide channels 138 on either side of link guide 132 while pressing the interchangeable ligation cover 102 so as to force pins 128 along sloped guide channels 138 and into substantially cylindrical guide recess 136. Guide recess 136 may advantageously be a substantially cylindrical recess with the outer edges of the recess defined by an interior surface of link guide 132.

Guide recess 136 may be slightly asymmetrical in cross section so as to better accept cylindrical pins 128. In other words, the radius R₁ (FIG. 3C) of a front portion of recess 136 is less than a radius R₂ of a bottom or rear portion of recess 136. Bottom or rear portion radius R₂corresponds to that portion of the recess 136 which first receives pins 128 during attachment of cover 102 to base 101. Such a configuration is particularly helpful when attaching or detaching cover 102 from base 101, as it provides something of a tolerance (i.e., play) when inserting or removing pins 128 from link guide 132.

A locking member 134 is defined by the portion of link guide 132 that is between channels 138. As seen in FIG. 5B, the width W of this locking member 134 is advantageously slightly greater than the distance D between inwardly oriented spaced apart pins 128 (FIGS. 4A and 5B). Furthermore, as seen in FIG. 5B, each pin 128 may advantageously include a convex outer surface 129 which reduces the amount of material that must flex in order to force pins 128 over locking member 134, as well as reducing the overall required assembling/dis-assembling force (i.e., contact occurs between the sides of locking member 134 and the outermost points of outer surfaces 129, rather than along the full outer surface 129). During attachment of cover 102 to base 101, pins 128 and the adjacent portion of cover 102 are elastically stretched or flexed so as to accommodate the width of locking member 134 of link guide 132. After pins 128 slide past locking member 134 (within channels 138) and are fully inserted within guide recess 136, pins 128 snap back to their original configuration, thereby forming a snap connection that captively retains ligation cover 102 to bracket base 101.

To remove the ligation cover 102, the orthodontic practitioner may use the reverse procedure. With the cover 102 in the open position, the pins 128 can be slightly stretched elastically so as to permit passage of the pins 128 out of guide recess 136, and into channels 138, detaching the ligation cover 102 from base 201. Once the ligation cover is slid out of channels 138, pins 128 snap back to their original configuration.

This particular joint configuration is advantageous as it allows for very simple assembly and dis-assembly of the orthodontic bracket, which is particularly helpful as the orthodontic brackets are very small (e.g., length of about 4 mm, width of about 2 mm, height of about 3 mm). As such, it can be quite difficult to orient the ligation cover 102 relative to the bracket base 101 as needed when assembling the bracket by hand. The illustrated embodiment only requires that the cover be aligned with the base, and then pressed in. In other words, no twisting is required during the aligning and attachment process. As such, the joint configuration of bracket 100 may be preferred over alternative hinge elements and/or hinge means.

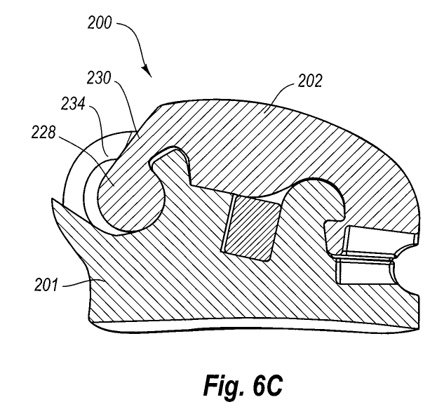

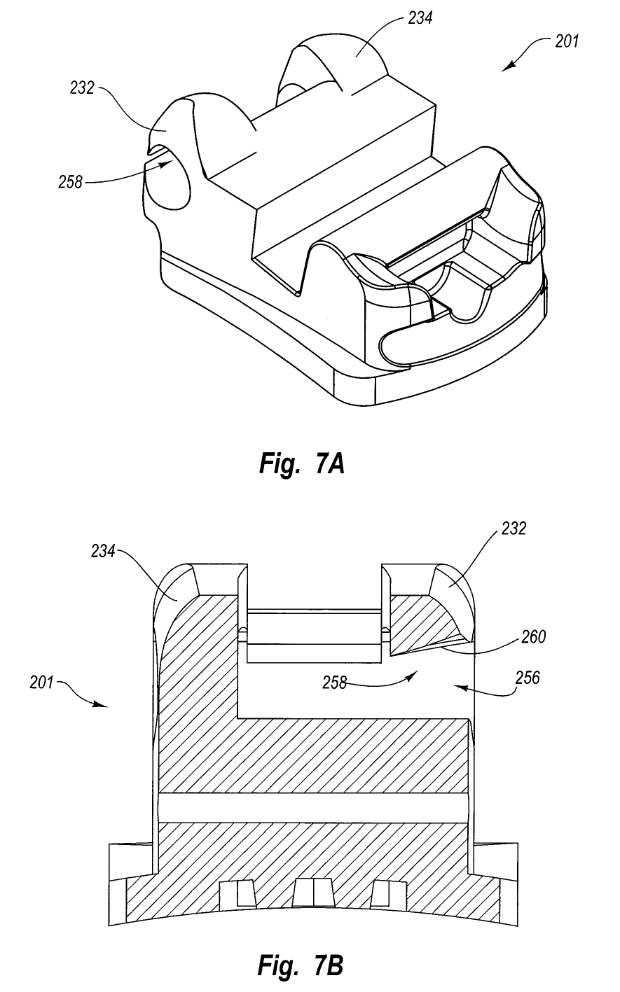

An alternative hinge joint for connecting a ligation cover to a bracket base is shown in FIGS. 6A-6C and 7A-7B, which illustrates a bracket 200 including a bracket base 201 and a ligation cover 202. Bracket base 201 similarly includes a pair of guides 210a and 210b, while ligation cover 202 similarly includes an occlusal front nose portion 214. The principal difference between bracket 200 and bracket 100 is the hinge element used to connect the ligation cover to the bracket base. Ligation cover 202 includes a pair of spigots 228 which are connected to the ligation cover 202 by means of a connection web 230 (perhaps best seen in FIG. 6C). In one embodiment, spigots 228 have a cylindrical cross-section. The spigots 228 are each received in a respective link guide 232 and 234 connected to bracket base 201. The spigots 228 and link guides 232 and 234 together comprise at least a portion of joint 203. The interaction between the spigots 228 and link guides 232 and 234 allow ligation cover 202 to be rotated about the pivot axis S between the open and closed positions.

The link guides 232 and 234 are in a spaced-apart relationship and include opposing inner surfaces that together define a guide recess 236. The inner surfaces of the link guides 232 and 234 also include chamfers 238. In use, the connection web 230 of the interchangeable ligation cover 202 can be inserted into the guide recess 236 while closing the interchangeable ligation cover 202 relative to the bracket base 201.

To facilitate assembly of ligation cover 202 with bracket base 201, at least one of link guides 232 and 234 may advantageously be provided with a passage opening 256 (FIG. 7B) which is dimensioned such that the spigots 228 can be pushed therethrough along the pivot axis S when the ligation cover 202 is in a completely open position relative to bracket base 201 (FIG. 6B). Link guide 232 further includes an auxilliary passage 258 having a ramped surface 260 that is inclined so as to cause the link guide 232 to be slightly stretched elastically so as to permit passage of connection web 230 through auxilliary passage 258. After connection web 230 is fully inserted through auxiliary passage 258, link guide 232 snaps back to its original configuration, thereby forming a snap connection that captively retains ligation cover 202 to bracket base 201.

To remove the ligation cover 202, the orthodontic practitioner may use the reverse procedure. The link guide 232 is slightly stretched elastically so as to permit passage of the connection web 230 out of auxiliary passage 258, detaching the interchangeable ligation cover 202 from base 201. Once the ligation cover is detached, link guide 232 snaps back to its original configuration. The joint 203 and its operation is described in greater detail in U.S. Pat. No. 6,964,565, entitled TWO-PART ORTHODONTIC BRACKET, which is hereby incorporated by reference. Hinged joints 103 and 203 are examples of hinge means for hingedly connecting a ligation cover to a bracket base. Other structures that provide hinged attachment between the cover to the base will be apparent to one skilled in the art, and such structures are within the scope of hinge means for hingedly connecting the ligation cover to the bracket base.

The bracket base and ligation cover of the orthodontic bracket may be formed of various materials. According to one embodiment, the bracket base is formed of at least one of metal, a ceramic, glass, or a polymeric resin. The bracket base preferably is formed of a metal or ceramic material so as to impart a high degree of strength to the bracket base, particularly the area surrounding the arch wire slot. The ligation cover is formed of at least one of metal, a ceramic, glass, or a polymeric resin. Preferred ceramic materials include, but are not limited to, aluminous oxide, zirconia, and porcelain. Examples of suitable metals include, but are not limited to, stainless steel, stainless steel alloys, titanium, and nickel-titanium alloys.

Preferred polymeric resin materials from which the bracket base and/or ligation cover may be formed include numerous thermoplastic materials. Examples of suitable thermoplastic materials include, but are not limited to, polyamides (crystalline or amorphous), acetal polymers, polyetherimides, polycarbonates, polyarylether ketones, polysulfones, and polyphenylsulfones.

Specific exemplary polymeric resin materials useful in forming orthodontic bracket bases and/or ligation covers include TROGAMID, a crystalline polyamide manufactured by Degussa AG, located in Germany; GRILAMID, an amorphous polyamide manufactured by EMS-CHEMIE AG, located in Germany; PEEK, a polyarylether ketone manufactured by Victrex USA, Inc., located in Greenville, S.C.; and RADEL, a polyphenylsulfone manufactured by Solvoy S.A., located in Brussels, Belguim.

Additional suitable polymeric resin materials and specific characteristics of the above polymeric resin materials and orthodontic bracket components formed therefrom, including methods for coating the bracket components, are disclosed in U.S. application Ser. No. 10/835,959, filed Apr. 30, 2004, and entitled ORTHODONTIC BRACKETS MADE FROM POLYMERIC MATERIALS THAT IMPART DESIRED STRENGTH PROPERTIES, and U.S. application Ser. No. 11/045,948, filed Jan. 28, 2005, and entitled ORTHODONTIC BRACKETS COATED TO INCREASE RESISTANCE TO WEAR AND DEFORMATION, both of which are hereby incorporated by reference.

According to one embodiment, the ligation cover and/or bracket base may be colored through incorporation of a dye or pigment into the forming material, especially where the bracket component is formed from glass or a polymeric resin material. The colored dye or pigment may comprise any desired color (e.g., red, white, blue, green, orange, black, yellow, purple, tooth colored, colorless, etc.). Bright and/or high contrast colors may be preferred by patients desiring to draw attention to their brackets, while low contrast colors (e.g., white, colorless, or tooth colored) may be preferred by patients wanting to hide or draw minimal attention to their brackets.

Alternatively, the ligation covers and/or bracket bases may include a colored coating. Colored coatings may be particularly preferred as a means of coloring the bracket component where the covers are formed from metal. Such a coating (e.g., a ceramic) may give a metal ligation cover and/or bracket base any desired color. Decorative images, graphics, figures, patterns, designs and/or other decorations may also be added, as desired. Additional details and methods of either incorporating a dye or pigment into the forming material or applying a coating which may be colored are disclosed in U.S. Pat. No. 7,134,872, U.S. patent application Ser. No. 11/613,767, filed Dec. 20, 2006 and entitled COLORED ORTHODONTIC BRACKETS HAVING REMOVABLE LIGATION COVER, and U.S. patent application Ser. No. 11/045,948, filed Jan. 28, 2005, and entitled ORTHODONTIC BRACKETS COATED TO INCREASE RESISTANCE TO WEAR AND DEFORMATION, each of which is hereby incorporated by reference with respect to its disclose of incorporating a colorant into a bracket forming material and applying a coating which may be colored.

In addition to decorative images, graphics, figures, patterns, or designs, other decorations, for example, decals, stickers, jewelry, or even small LED lights may be incorporated into or applied over the ligation cover. Such features, as well as high contrast colors (i.e., colors providing a high degree of contrast against the teeth, for example, fluorescent and/or bright colors) may be particularly desirable to those patients wishing to draw attention to their brackets. Other patients may instead want to minimize the appearance of their orthodontic brackets, and may choose for example, white, colorless (i. e., clear) or tooth colored ligation covers and/or bracket bases. Such options associated with the bracket advantageously allow each patient to tailor the aesthetic appearance of their overall bracket system to their particular tastes. In addition, because the ligation cover is removable from the bracket base as described above, the covers may be removed from the bracket bases (even while the bracket base is attached to the tooth) and replaced with a different cover having a different color, image, graphic, figure, pattern, designs, or other decoration during treatment.

Furthermore, it will be noted that when installed, the ligation cover largely hides the underlying bracket base from the view of someone looking at the patient. Such a characteristic is advantageous as it allows the user to create and change the appearance of the ligation covers while minimizing any color clashing or mismatching which might otherwise be undesirable between the ligation cover and the bracket base. This is particularly advantageous when replacing one or more interchangeable ligation covers while leaving the bracket bases still bonded or otherwise attached to the teeth. In addition, it maximizes the visible surface area available for application of decorative images, graphics, figures, patterns, designs, or other decorations to the front labial-buccal surface of the ligation cover. Maximizing this surface area is advantageous as the brackets are already very small such that the maximized cover surface makes any applied decoration more easily visible, distinguishable, and/or recognizable.

The ligation cover may advantageously be impregnated and/or coated with a medicament (e.g., fluoride). Such an embodiment allows the practitioner to replace a ligation cover with a new ligation cover once the medicament within the first ligation cover has been depleted. Such a replacement can be performed quickly and easily with little discomfort to the patient as removal and rebonding of the bracket base is not required. Administration of fluoride may be particularly advantageous during orthodontic treatment involving the use of brackets as it can be quite difficult for a patient to maintain clean teeth (particularly those portions of the teeth near the brackets) during the orthodontic treatment. Administration of fluoride may at least partially offset any tendency for increased tooth decay during such treatment.

FIGS. 8 illustrates the exemplary bracket 100 of FIG. 1 bonded to a tooth 550. As shown, a dental scaler 552 or other dental tool is required to unlock cover 102 from base 101 so as to open the cover 102. The scaler 552 is inserted within safety unlocking recess 126, and force is outwardly applied so as to unlatch cover 102 from base 101. As discussed above, the width of cover 102 at the occlusal edge 115 is reduced relative to the width of the remainder of the cover so that the front, occlusal nose portion 114 of cover 102 is received between guides 110a and 110b. One result of this reduced occlusal edge width at 115 is that it is difficult or impossible to open cover 102 with one's fingernail. Unlocking recess 126 may advantageously have a width between about 0.25 mm and about 1 mm, more preferably between about 0.5 mm and about 0.75 mm, which is sufficiently small so as to prevent insertion of a fingernail for opening. As such, safety unlocking recess 126 acts as a safety locking/unlocking structure, reducing the possibility that a patient will unlock cover 102 from base 101 once cover 102 is locked in a closed position. Such features (i.e., small width of recess 126 and reduced width of edge 115) are advantageous as they prevent or at least minimize the possibility that a patient may accidentally or intentionally open the cover, which might otherwise interfere with the orthodontic treatment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An orthodontic bracket comprising:
a bracket base including at least one arch wire slot formed therein, the arch wire slot being adapted to receive an arch wire therein;
a pair of spaced apart guides disposed on the bracket base, each guide extending from the base in a labial-buccal direction so as to define a receiving cavity between the guides;
a ligation cover that is selectively movable relative to the bracket base between an open, non-ligating position relative to the at least one arch wire slot and a closed, ligating position relative to the at least one arch wire slot, the ligation cover including an occlusal front nose portion configured to be received within the receiving cavity when the cover is closed; and
a hinge element that hingedly connects the ligation cover to the bracket base.

2. An orthodontic bracket as recited in claim 1, further comprising a safety unlocking recess formed into the occlusal front nose portion of the ligation cover and/or the bracket base.

3. An orthodontic bracket as recited in claim 2, wherein the safety unlocking recess has a width between about 0.25 and about 1 mm.

4. An orthodontic bracket as recited in claim 2, wherein the safety unlocking recess has a width between about 0.5 mm and about 0.75 mm.

5. An orthodontic bracket as recited in claim 1, wherein the guides are disposed near the occlusal edge of the bracket base, the guides being spaced apart such that one guide is disposed near an occlusal-mesial comer of the bracket base and the other guide is disposed near an occlusal-distal comer of the bracket base.

6. An orthodontic bracket as recited in claim 1, wherein the occlusal front nose portion of the ligation cover has a width that is less than an adjacent width of the ligation cover which is gingival to the occlusal front nose portion, such that the occlusal front nose portion is configured to be received within the receiving cavity between the guides.

7. An orthodontic bracket as recited in claim 1, wherein the hinge element for hingedly connecting the ligation cover to the bracket base comprises a pair of inwardly oriented pins formed on the ligation cover and a link guide formed on the bracket base, the link guide having a guide recess for captively retaining the inwardly oriented pins such that the ligation cover can be selectively pivoted relative to the bracket base between an open, non-ligating position and a closed, ligating position relative to the at least one arch wire slot.

8. An orthodontic bracket as recited in claim 1, wherein the hinge element for hingedly connecting the ligation cover to the bracket base comprises a pair of spigots formed on the ligation coves and a pair of link guides formed on the bracket base for receiving the spigots.

9. An orthodontic bracket as recited in claim 1, wherein the bracket base is formed from at least one material selected from the group consisting of metal, ceramic, and glass.

10. An orthodontic bracket as recited in claim 9, wherein the bracket base is formed from a ceramic and comprises at least one of aluminous oxide, zirconia, or porcelain.

11. An orthodontic bracket as recited in claim 1, wherein the ligation cover is formed from at least one material selected from the group consisting of metal, ceramic, glass, and a polymeric resin.

12. An orthodontic bracket as recited in claim 11, wherein the ligation cover is formed of at least one polymeric resin selected from the group consisting of a polyamide, an acetal polymer, a polyetherimide, a polycarbonate, a polyarylether ketone, a polysulfone, and a polyphenylsulfone.

13. An orthodontic bracket as recited in claim 12, wherein the ligation cover is formed of a polymeric resin comprising a crystalline polyamide.

14. An orthodontic bracket as recited in claim 12, wherein the ligation cover is formed of a polymeric resin comprising an amorphous polyamide.

15. An orthodontic bracket as recited in claim 1, wherein the ligation cover and/or bracket base include a decorative image, graphic, figure, pattern, design, or other decoration.

16. An orthodontic bracket comprising:
a bracket base including at least one arch wire slot formed therein, the arch wire slot being adapted to receive an arch wire therein;
a pair of spaced apart guides disposed at or near an occlusal edge of the bracket base, each guide extending from the base in a labial-buccal direction so as to define a receiving cavity between the guides;
a ligation cover that is selectively movable relative to the bracket base between an open, non-ligating position relative to the at least one arch wire slot and a closed, ligating position relative to the at least one arch wire slot, the ligation cover including an occlusal front nose portion configured to be received within the receiving cavity when the cover is closed;
a hinge element that hingedly connects the ligation cover to the bracket base; and
a safety unlocking recess formed into the occlusal front nose portion of the ligation cover and/or the bracket base so as to prevent or at least inhibit opening of the ligation cover by a patient when the ligation cover is closed.

17. An orthodontic bracket as recited in claim 16, wherein the safety unlocking recess has a width between about 0.25 and about 1 mm.

18. An orthodontic bracket as recited in claim 16, wherein the safety unlocking recess has a width between about 0.5 mm and about 0.75 mm.

19. An orthodontic bracket comprising:
a bracket base including at least one arch wire slot formed therein, the arch wire slot being adapted to receive an arch wire therein;
a ligation cover that is selectively movable relative to the bracket base between an open, non-ligating position relative to the at least one arch wire slot and a closed, ligating position relative to the at least one arch wire slot,
means for resisting lateral movement of an occlusal front portion of the ligation cover as the cover is closed over the bracket base; and
hinge means for hingedly connecting the ligation cover to the bracket base.

20. An orthodontic bracket as recited in claim 19, further comprising safety locking means for preventing or inhibiting opening of the ligation cover by a patient when the ligation cover is closed.
